(19) United States
(12) Patent Application Publication
(10) Pub. No.: US 2024/0428182 A1
(43) Pub. Date: Dec. 26, 2024

(54) INTERACTIVE MATERIAL DISTRIBUTION SYSTEM

(71) Applicant: TruckTrax, LLC, Vancouver, WA (US)

(72) Inventors: Steven A. Fain, Vancouver, WA (US); Brian E. Mansell, Bellevue, WA (US); John M. Whalley, Vancouver, WA (US); Jan G. Eugenides, Vancouver, WA (US); David M. Leatham, Kent, WA (US)

(21) Appl. No.: 18/651,070

(22) Filed: Apr. 30, 2024

Related U.S. Application Data
(63) Continuation of application No. 16/020,750, filed on Jun. 27, 2018, now abandoned.
Application No. 16/020,750 is a continuation of application No. 13/426,430, filed on Mar. 21, 2012, now abandoned.
(60) Provisional application No. 61/454,934, filed on Mar. 21, 2011.
(60) Provisional application No. 61/526,641, filed on Aug. 23, 2011.

(51) Int. Cl. G06Q 10/0835; G06Q 10/08; G06Q 40/12; G07C 5/00; G07C 5/02; G08G 1/00

(52) U.S. Cl. CPC G06Q 10/08355; G06Q 10/08; G06Q 40/125; G07C 5/008; G07C 5/02; G08G 1/20; G08G 1/202; G08G 1/207

(57) ABSTRACT

A system that includes an interactive mobile computing device and a remote dispatch computing system. The remote dispatch computing system defines geozones for pick-up and delivery locations of perishable bulk materials. The remote dispatch computing system determines a series of multiple deliveries and assigns them to a plurality of users. The interactive mobile computing device of a user determines if it is in either of the geozones and performs various actions accordingly, including requesting manifest information for the series of deliveries, modifying a user interface to present to the manifest information to the user, generating modified manifest information, and transmitting the modified manifest information to the remote dispatch computing system. In response, the remote dispatch computing system modifies scheduled event times for at least one of the series of deliveries, which includes preventing at least one subsequent delivery of the bulk material to a given amount of time.

### CROSS-REFERENCE TO RELATED APPLICATIONS

This application claims the benefit under 35 U.S.C. § 119(e) of U.S. Provisional Patent Application No. 61/454,934 filed Mar. 21, 2011, and of U.S. Provisional Patent Application No. 61/526,641 filed Aug. 23, 2011, and of U.S. patent application Ser. No. 13/426,430 filed Mar. 21, 2012 under 35 U.S.C. § 120, and of U.S. patent application Ser. No. 16/020,750 filed Jun. 27, 2018 under 35 U.S.C. § 120, each of which are incorporated herein by reference in their entirety.

### BACKGROUND

### Technical Field

The invention relates to a tracking and management system, and more particularly, a method and system for automating tracking and managing individuals, vehicles, fleets of vehicles, and/or information.

### Description of the Related Art

The delivery of bulk construction materials has been historically difficult to manage efficiently. Traditionally, delivery information has been communicated to the truck driver over telephone or radio and then transmitted to the customer via printed delivery tickets issued after the driver received the payload. This method often yields significant inefficiencies because a user cannot monitor unbudgeted overtime, update charges to the customer, account for excess unloading times, track and handle truck breakdowns, account for lost tickets, correct transcription errors, know the exact delivery address and travel time to a job, and the like.

To efficiently manage their fleets, operators of fleet vehicle businesses (e.g. operators of businesses in delivery of bulk construction materials) need to know where each vehicle in the fleet is located and each vehicle's status (e.g., delivery state, operational condition, etc.) in order to adjust the overall delivery plan without delay to react to changing circumstances and to accurately invoice to reflect those changes. Two-way radio communication has dominated the industry and vehicle locating systems incorporating Global Positioning System (GPS) receivers have been used to track fleet vehicles. Unfortunately, with these traditional systems a user cannot manipulate and edit the delivery ticket to complete a delivery and dispatch a subsequent load from the remote jobsite and cannot sync up to determine surcharges (e.g., calculate relevant surcharges) and complete delivery information with a point of sale software system for subsequent invoicing.

### BRIEF SUMMARY

At least some embodiments are directed to a system that allows access to software and information without knowledge of, expertise with, or control over the technology infrastructure supporting the application. The system can include at least one mobile computing device that provides benefits over the traditional fixed hardware-centric systems in which dedicated communication and computing equipment is permanently installed in a vehicle. The benefits include, without limitation, reduced costs, increased computing flexibility, application mobility, increased computing capability, on-demand procurement and the ability to update the software. The software can be updated remotely, if needed or desired.

A system can include one or more mobile devices that perform functions without use of an on-board computer permanently installed in a vehicle. On-board computers are often expensive, maintenance intensive, and prone to malfunctions. In some embodiments, the mobile devices may be electronically tethered to the vehicle for data collection, vehicle monitoring, communication, or combinations thereof. The mobile devices may be portable and inexpensive while being capable of performing a wide range of operations and can be carried around job sites, plants, or other locations. Mobile devices can be used to show information to customers. The information can include, without limitation, how the final invoice will be calculated, information used to generate an electronic ticket, delivery schedules, route information, or the like. If desired, a user can carry the mobile device throughout an entire shift. The mobile device can perform calculations, store data, capture images, collect data, sense forces/accelerations, and the like and can be in the form of a smartphone, a cellular phone, a PDA, a tablet, or the like.

A user can use the mobile device to manipulate and edit a delivery ticket to complete a delivery and dispatch a subsequent load from the remote jobsite. The mobile device can sync up and complete delivery information with a point of sale software system for subsequent invoicing. In certain embodiments, the delivery ticket can be updated and another vehicle (e.g., a truck) is dispatched without requiring any information or communication with a remote computer or an on-board computer, or both.

In some embodiments, a mobile device includes one or more applications that, when activated, causes the mobile device to communicate with a remote, hosted database (e.g., GeoTrax Master Database (Master)). Based on the subscription, the database can function as a data repository for the mobile application, returns the location of a users local database (e.g., GeoTrax Snap Database (Snap)), or the like. When the subscription is validated and communications protocol set, the application communicates with a web application to perform a variety of functions.

The mobile device, in some embodiments, includes one or more applications that can be executed to perform one or more functions. The functions can include, without limitation, record keeping, billing, obtaining information, determining locations, calculating charges (e.g., surcharges), or combinations thereof. Applications can include, without limitation, one or more databases, application programming interface routines (APIs), operating systems (e.g., iOS, APPLE OS, WebOS, Android, WINDOWS Mobile, WINDOWS Phone, etc.), instructions, routines, or the like.

To determine the location of the mobile device, the mobile device can include one or more positioning devices, such as a GPS receiver. The positioning device can communicate with cell-phone towers, satellites, or other network-derived components, and sensors. The geographic location is evaluated to determine the mobile device's relationship to one or more geozones and establish whether a geofence breach has occurred. In some embodiments, the defined area is a geographic polygon referred to as a “geozone.” The geozone can be the area inside of a geofence. Logic is applied to data including, without limitation, the geographic position of the device in relation to an established geozone, the nature of the geozone, whether or not a geofence breach has occurred, the type of breach that has occurred, and/or the existence of tethered events to automatically determine the occurrence of a number of events, including delivery status and the like. Other types of data can be used by the logic. The mobile device can be programmable with executed code or instructions with the logic.

Additionally or alternatively, the user can directly provide information to the device (e.g., locations, addresses, destinations, departure times, route information, delivery times, or the like). The manually entered information can also be inputted using a web-interface.

The mobile device can perform timekeeping. A user can clock into a timekeeping system using the mobile device functioning as an electronic timecard. To access the payroll system, the system may require a user to be within a defined geozone. Upon clocking into the system, information related to hours worked for the current pay period are displayed. In some embodiments, the required information for FMSCA drivers hours of service compliance is monitored and displayed consistent with government requirements (e.g., U.S. Federal requirements for the Electronic on-board recorders or other government requirements). The device may communicate wirelessly with a vehicle's systems to identify the equipment being operated and to electronically link the device to the vehicle. The precise location of the mobile device as well as date and time are recorded when the driver punches into the timekeeping system. The time is compared to an electronic schedule that contains the driver's scheduled starting time and vehicle assignment. If the time is outside a pre-determined window, the system returns a message to the device informing the driver of the scheduled start time and that the clock-in time is outside the acceptable range. The driver may acknowledge the variance before the punch-in time is accepted. The web application may communicate with a 3rd party dispatch system to access an electronic schedule that contains the driver's assigned truck. A drop down list may be provided for the driver to select an alternative vehicle if the assigned vehicle is unavailable.

An electronic pre-trip safety checklist can be displayed on the device's touch screen for the driver to confirm that the vehicle's systems are operable and that the truck is suitable for deliveries. Any deficiency of the truck's systems may be sent wirelessly to the dispatch system or truck shop where the decision is made to drive, repair or park the truck. Once the truck is confirmed as mechanically sound, the driver may be prompted to verify the electronic identification of the truck and link the truck to the mobile device. The scheduled plant to load at may be displayed on the touch screen.

Upon arrival at the plant, the driver can be prompted to confirm that the truck is ready to load by checking a box on the device's user interface. In some embodiments, a truck's ready to load status is automatically generated when it arrives in a batching plant's loading queue geozone. When the truck is ready to load, the device begins polling the dispatch system to determine whether a delivery ticket has been generated for the truck.

In at least some ready-mix concrete embodiments, the delivery ticket information displayed on the screen includes, without limitation, the ticket number, the quantity and slump of the desired mix, the delivery address, batch weights, previous and subsequent vehicles scheduled, the scheduled arrival time, and notes, if any, for the driver. The ticket package can include all the formulas necessary for the device to perform the billing calculations necessary to complete the ticket and display the information without any further communication with the dispatch system.

In touch screen embodiments, the mobile device can include virtual touch screen buttons and can display, without limitation, delivery maps, turn-by-turn navigation, and traffic overlays. The driver can view the scheduled times for various delivery events. Delivery status and billing surcharges are determined by the application by applying logic to pre-determined criteria. Event times can be displayed and can be edited by the user using the device. When a delivery is complete, all products, billing times, and surcharges can be displayed on the touch screen. An electronic signature can be captured and attached to the delivery manifest. Upon completion, the delivery manifest, including the captured signature, may be sent electronically to the customer's email Inbox and a copy is deposited in their eFolio accessible through a customer portal.

Two-way text messaging, verbal communication through digital push-to-talk (PTT) technology, and streaming interactive safety and training computer based training courses can be provided. The touch screen can be used during the training.

The mobile device can capture images. Digital photos and video taken from either the device or truck mounted cameras can be displayed on the device and attached to the electronic ticket.

The mobile device can store information from different types of sensors. The sensors can include pressure sensors, force sensors, accelerometers, gyroscopes, or the like. In some embodiments, the mobile device has at least one 3-axis accelerometer and at least one 3-axis gyroscope. Data from the sensors is recorded, stored, and/or transmitted to a remote server allow recreation of the data in the event of a safety incident or traffic accident, to track the vehicle, provide user feedback (e.g., notifications of excessive accelerations, decelerations), calculate a driver's ranking (e.g., safety ranking, on-time ranking, etc.), or the like.

In dump and haul applications, the mobile device can receive and cache multiple delivery tickets. At the time of dispatch a driver's expected ticket packages for the day are sent to the application. The ticket packages may include delivery information, including, without limitation, an expected loading location, truck ID, hauler ID, freight billing information, customer name and number, delivery address (including jobsite/plant geozones), product number and description with approximate quantity, billing information (including possible surcharges, taxes, etc.), and other desired delivery information.

Upon arrival at a loading location, if the truck has an active ticket package for the location, the ticket can be automatically displayed on the device's touch screen. The loading location can be a building site, pit, plant, quarry, or the like. If there are multiple deliveries to be made from that location, then a user can pick from a list showing the tickets, products, and approximate quantities. Upon selection of the ticket, the driver will be instructed to load. After loading, the tonnage may be relayed via a network (e.g., a local network, a Wi-Fi network, etc.) to the device and the driver instructed to proceed to the unloading location. At locations without networks (e.g., without wireless communications), a virtual numeric keypad will display on the device and the driver instructed to manually input the gross loaded weight of the vehicle. Tare weights and maximum gross tonnage for each vehicle are maintained in a database (e.g., a GeoTrax_snap database) and can be updated either manually or by a network.

Information can be associated with a ticket. When the truck leaves the loading zone and arrives at the unloading zone, a time stamp or other information can be associated with the delivery ticket. Upon arrival at a Wi-Fi equipped facility, information is automatically communicated between the mobile device and the Wi-Fi network. For example, completed delivery ticket information can be automatically downloaded into the billing system and invoices can be generated automatically.

A machine readable medium, in some embodiments, contains program code, instructions, executable code, and/or information, such as one or more applications. A processing device (e.g., a CPU, computing device, etc.), digital processing unit, or other component of a mobile device can be used to perform a process.

### BRIEF DESCRIPTION OF THE SEVERAL VIEWS OF THE DRAWINGS

FIG. 1 is a schematic illustration of the data transfer to and from a mobile device.

FIG. 2 is a flowchart illustrating the initialization of a system and communication with a GeoTrax hosted Snap database and third party dispatch software.

FIG. 3 is a flowchart illustrating the initialization of a system and communication with a locally hosted (at a customer location) Snap database and third party dispatch software.

FIG. 4 is a flowchart illustrating initialization and startup of a system including subscription validation.

FIG. 5 is a flowchart illustrating the conceptual operation of the system.

FIG. 6 is an illustration of the logic employed to determine whether a geographic location is inside our outside of a geozone.

FIG. 7 is an illustration of the concept of overlapping and nested geozones.

FIG. 8 is an illustration of stacked mutually exclusive (nested) geozones.

FIG. 9 is an example of the logic employed to determine geozone precedence when the device is within the boundaries of two mutually exclusive geozones of the same type.

FIG. 10 is filtering logic employed to block errant or stale GPS data from breach determination, in accordance with one embodiment.

FIG. 11 is a screenshot from a mobile device running GeoTrax Mobile Application illustrating the driver's login screen.

FIG. 12 is a screenshot from a mobile device illustrating a welcome screen with the total hours worked week to date and month to date. Driver's DOT hours of service will be displayed on this screen.

FIG. 13 is a flowchart illustrating the Personal Identification Number (PIN) validation procedure of the system.

FIG. 14 is an illustration of the logic that allows a user to log in to the system and have the application function as an electronic time card.

FIG. 15 is a screenshot from a mobile device illustrating the screen displaying the driver's scheduled truck information.

FIG. 16 is a screenshot from a mobile device illustrating the driver's picklist of available alternative trucks.

FIG. 17 is a screenshot from a mobile device illustrating the completed electronic pre-trip checklist where one or more systems have failed.

FIG. 18 is a screenshot from a mobile device illustrating the driver's scheduled loading plant.

FIG. 19 is a screenshot from a smartphone illustrating the ticket polling screen to display the next scheduled delivery.

FIG. 20 is a screenshot from a mobile device illustrating the driver's current ticket.

FIG. 21 is a flowchart illustrating the vehicle validation and delivery assignment notification procedure.

FIG. 22 is a screenshot from a mobile device illustrating the non- editable delivery times of the current ticket.

FIG. 23A is a table depicting the default communication settings for maximizing battery life.

FIGS. 23B and 23C are a flowchart illustrating how delivery geofence breach logic manages mobile device battery life and determines whether a breach is an entrance to a delivery geozone, an exit from a delivery geozone, an informational geozone, or inconsequential.

FIGS. 24A, 24B, and 24C are a flowchart illustrating how the application determines appropriate event times based upon breach direction, delivery status, and user input.

FIG. 25 is a screenshot from a mobile device illustrating the delivery manifest of the current ticket.

FIG. 26 is a screenshot from a mobile device illustrating the screen for the recipient's signature to be attached to the manifest of the current ticket.

FIG. 27 is a screenshot from a mobile device illustrating the recipient's signature on the manifest of the current ticket.

FIG. 28 is a flowchart illustrating the logic used to evaluate data prior to alerting the driver of a possible rollover situation.

### DETAILED DESCRIPTION

Program procedures can be executed on a mobile device, a computing device, a computer, or network of computers. A mobile device can be, without limitation, a smartphone, a personal digital assistant (PDA), a tablet PC, or the like. Handheld mobile devices in the form of smartphones can be conveniently carried and stored in relatively small spaces. A smartphone can be a mobile phone that offers more advanced computing ability and connectivity than a general purpose cellular phone and features, for example, one or more digital cameras, one or more microphones, one or more speakers, a touch-screen interactive display, one or more accelerometers, one or more gyroscopes, and the ability to install and run applications.

Procedural descriptions and representations are the means used by those skilled in the art to most effectively convey the substance of their work to others skilled in the art. A procedure can be a self-consistent sequence of steps leading to a desired result. These steps are those requiring physical manipulations of the physical quantities. Sometimes these quantities take the form of electrical or magnetic signals capable of being stored, transferred, combined, compared and otherwise manipulated. It proves convenient at times, principally for reasons of common usage, to refer to these signals as sensors, transmissions, bits, data, values, elements, symbols, characters, terms, numbers, or the like. It should be noted, however, that all of these and similar terms are to be associated with the appropriate physical quantities and are merely convenient labels applied to these quantities. Further, the manipulations performed are often referred to in terms, such as adding or comparing, which are commonly associated with mental operations performed by a human operator. No such capability of a human operator is necessary, or desirable in most cases, in any of the operations described herein, which form part of the present invention; the operations are machine operations.

At least some embodiments of the invention relate to an asset allocation and management system of delivery trucks for multiple product streams, multiple loading sites and multiple delivery sites. Table 1 identifies, without limitation, the bulk construction materials delivery product streams managed by at least some embodiments of the invention.

TABLE 1

| Product | |
|---|---|
| Stream | Description |
| Ready- | Information related to the |
| mix | scheduling and delivery of ready- |
| | mixed concrete |
| Aggregate | Information related to the |
| | scheduling and delivery of bulk |
| | aggregates |
| Bulk | Information related to the |
| Cement | scheduling and delivery of bulk |
| | cement |
| Other | Information related to the |
| | scheduling and delivery of various |
| | bulk commodities |

Ready-mixed concrete truck delivery coordination may be particularly important because fresh concrete is a perishable product that loses quality if not placed in its final form in 90 minutes or less. For best results, each load of concrete must be consolidated with the prior loads to form a homogeneous mass. For projects requiring more than one truckload of concrete, the sequencing of truck arrivals is important. When the concrete is put into place and is no longer agitated, the hydration of the cement in the mix will cause the concrete to “set” and harden. Once this process has begun, it is no longer possible to consolidate the concrete with subsequent loads, resulting in a seam or “cold joint” between loads. The cold joint is unsightly and a weak point in the concrete structure. Systems can be used to increase the efficiency and coordination of each component of the delivery cycle to improve the quality of the finished product.

Bulk aggregate and cement delivery coordination can offer a completely different set of challenges. In general, because of the specialized nature of the trucks and the need for coordinated arrival at a jobsite, ready-mixed concrete producers often deliver their product in trucks they either own or directly control. That is often not the case with bulk aggregate and cement delivery. Frequently, based on the differing product availability and travel times, these delivery trucks do not return to their originating plant between deliveries for dispatch. Electronic tickets can be generated for these types of deliveries to eliminate paper tickets and the associated overhead needed to process these types of tickets.

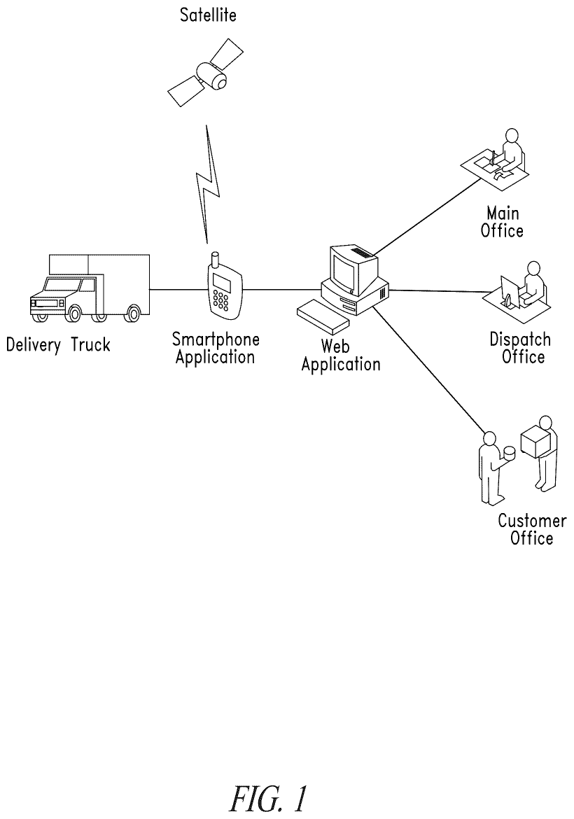

FIG. 1 is a block diagram of the communications system network utilized by the application. The application can run on a mobile device that has a data connection. The data connection may be a cellular connection, a wireless data connection, an internet connection, an infra-red connection, a short wavelength radio transmissions (e.g., a BLUETOOTH® connection), or any other connection capable of transmitting data. A network environment can provide communication and may include, without limitation, one or more antennas, mobile applications, user interfaces, service providers, network administrators, data stores, web applications, and third party standalone applications. Not all of the depicted components may be required however, and some implementations may include additional components. Additional, different or fewer components may be provided. The components of the network environment can be selected based on the desired functionality.

FIG. 1 illustrates the device communications including the Global Positioning System (GPS) satellites, an on-board data network of a delivery truck, and a web application. The web application communicates with the main office network, the dispatch center network, and a customer's office network. The networks may include, without limitation, wide area networks (WAN) such as the Internet, local area networks (LAN), metropolitan area networks, or any other networks that may allow for data communication. The device may communicate with a delivery truck via BLUETOOTH®, Wi-Fi, two-way radio or direct connection with the truck operating systems.

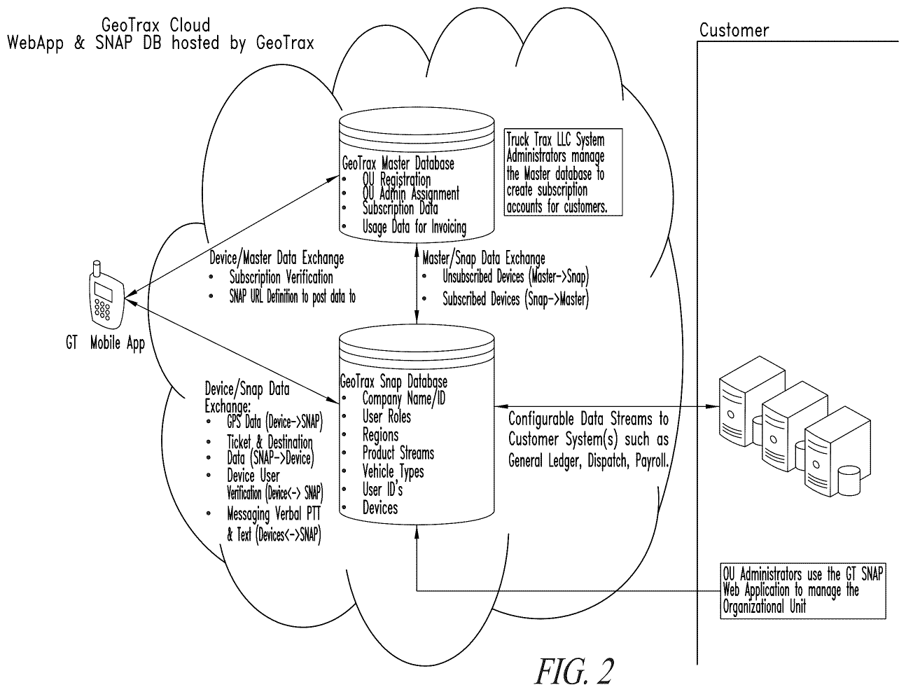

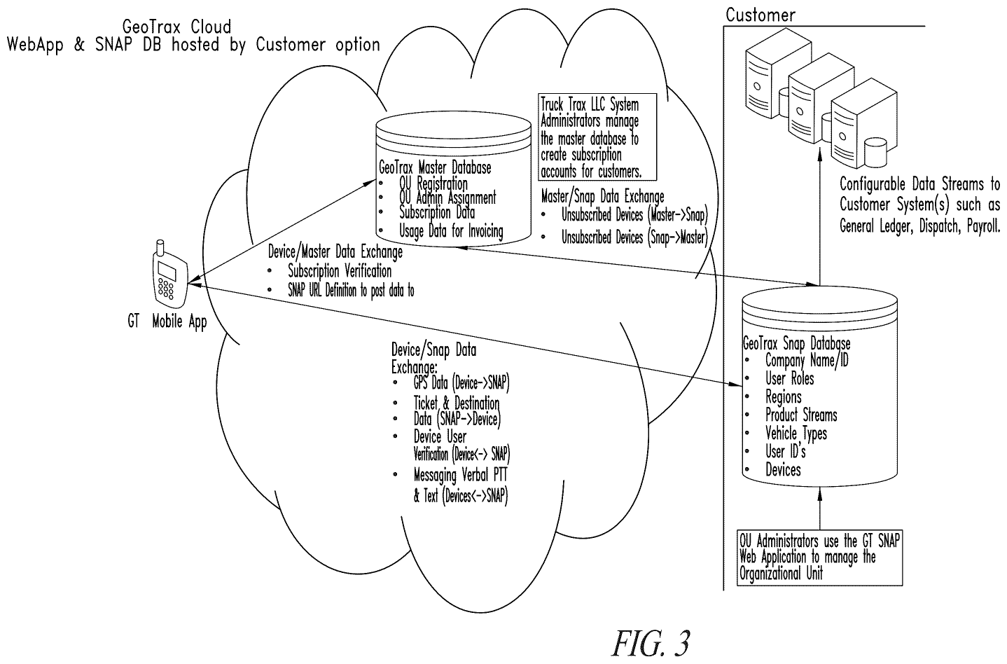

FIG. 2 is a flowchart illustrating the initialization of the system. Initialization of the system includes downloading one or more applications from a network (e.g., a secured network) or from a commercial storefront (e.g., Google Market) and installed on the mobile device(s). The GeoTrax data repository configuration consists of two separate types of databases:
GeoTrax ‘Master’ Database (Master)—This internet (i.e. Cloud based) exposed database contains the subscription information for Organizational Units (OU) that purchase access to the system and the redirect data path(s) for the mobile devices to report the status and location data. There can be more than one Master database for purposes of load balancing and scaling. The types of Master databases are:
   Primary—All devices are directed at startup for contact with the primary Master for their long term Master server assignment.
   Secondary—Master database(s) that provides additional resources to the Master solution space.
GeoTrax ‘Snap’ Database (Snap)—The Snap database's purpose is to house a organizational unit(s) position and ticket data and share it with their internal systems (General Ledger, Dispatch, Order Fulfillment, Payroll, etc.). The Snap database uses a hosted solution in the internet cloud or, in an alternative embodiment, can be hosted internally by the customer (FIG. 3). Updates for devices are dispersed from the OU Snap server and releases are controlled by the OU administrators. A Snap can host multiple OUs. An OU may have multiple Snap for load balancing or for customer internally hosted embodiment, multiple Snap databases for quicker response times when related systems such as dispatch are dispersed across a WAN (Wide Area Network).

Users can be notified when software updates are available and can be downloaded manually or automatically. Once installed and started, the application automatically gathers information from the device. The information can include, without limitation, the device ID (IMEI), phone number, operating system information, or combinations thereof. Device IDs are unique and are embedded by the manufacturer of the mobile device. The phone number can be automatically obtained if available from the device's operation system or by manual input. The identity data from the device is automatically posted to a Master database (e.g., a GeoTrax Master database) and copied to the OU supplied URL for their GeoTrax Snap database (Snap). If the device is not associated with an OU (e.g., subscribing organizational unit), the mobile device is identified as an unsubscribed device. If the device is associated (i.e. subscribed by an OU administrator) to an OU, the device data is also copied to the designated GeoTrax Snap database (Snap).

A customer designated user (e.g., OU system administrator) captures unsubscribed devices (or subscribed devices if they are to report to multiple OUs) and assigns them to the OU through a web application. The system administrator assigns one or more identifying parameters to the web application. The parameters may include, without limitation, the subscribing Company Name, ID, and subscription information. The company administrators can have access to the parameters, the regions identified for the purpose of segregating the information, the product streams that will be managed by the application, the vehicle types that the deliveries will be assigned to, the identification of all approved users of the system, identification by device of a 3rd party dispatch system to send signal data to and from, and the unique identifications of all the devices that are approved for access to the system.

The mobile device stores the connection data for the GeoTrax Snap database (Snap) internally. Every initialization\startup of the phone application re-queries the GeoTrax Master database (Primary or assigned secondary) for the GeoTrax Snap Server's target URL (Uniform Resource Locator). If it is unable to get this from its startup routine communication to GeoTrax Master database, it will use the last known successful GeoTrax Snap connection for a configurable amount of time (typically 30 days) after which the stored connection data for GeoTrax Snap database will be marked as stale and no longer viable. A “Connection Unavailable” message will display on the GeoTrax mobile application.

On a configurable periodic basis, the mobile application can validate a customer account to determine the status of the account. If the account is in good standing, the mobile application will continue to access information. If the device does not validate the account within a configurable time period, the mobile application can notify the user and block usage.

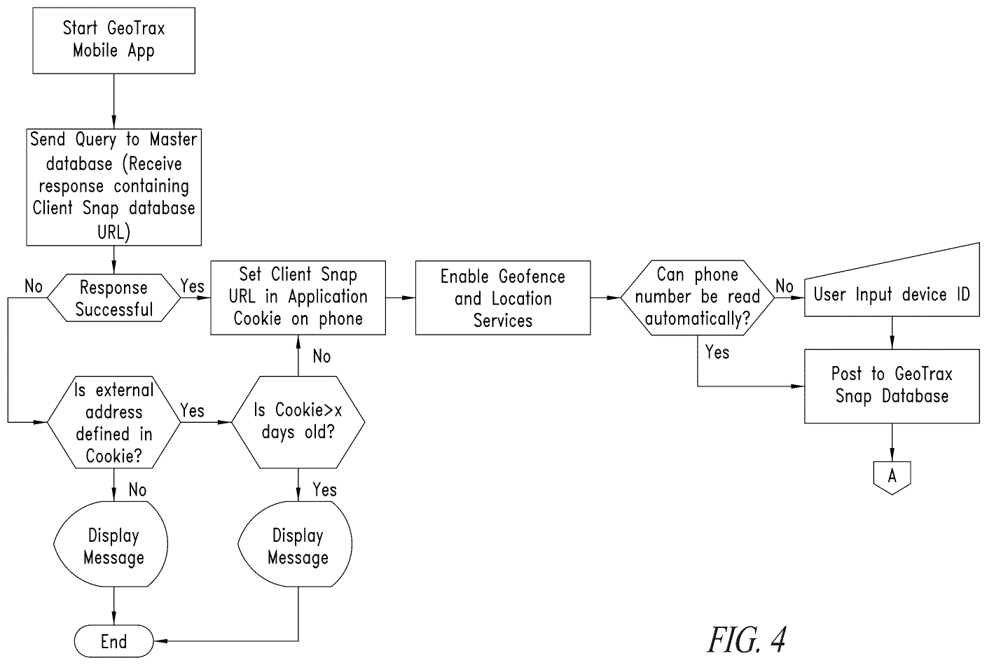

FIG. 4 is a flowchart illustrating the initialization and startup of the system including subscription validation. When the application is activated on the mobile device, a query is sent to the Master database (Master) to determine the status of the device. If the device is valid and currently subscribed to the system and if there is a valid Snap database for communicating with the application, the device can be activated on the system and information posted to the Snap. If the device is valid but the subscription is not current, the system evaluates whether the subscription is within the grace period allowed. If so, the device is activated on the system and information posted to the Snap database.

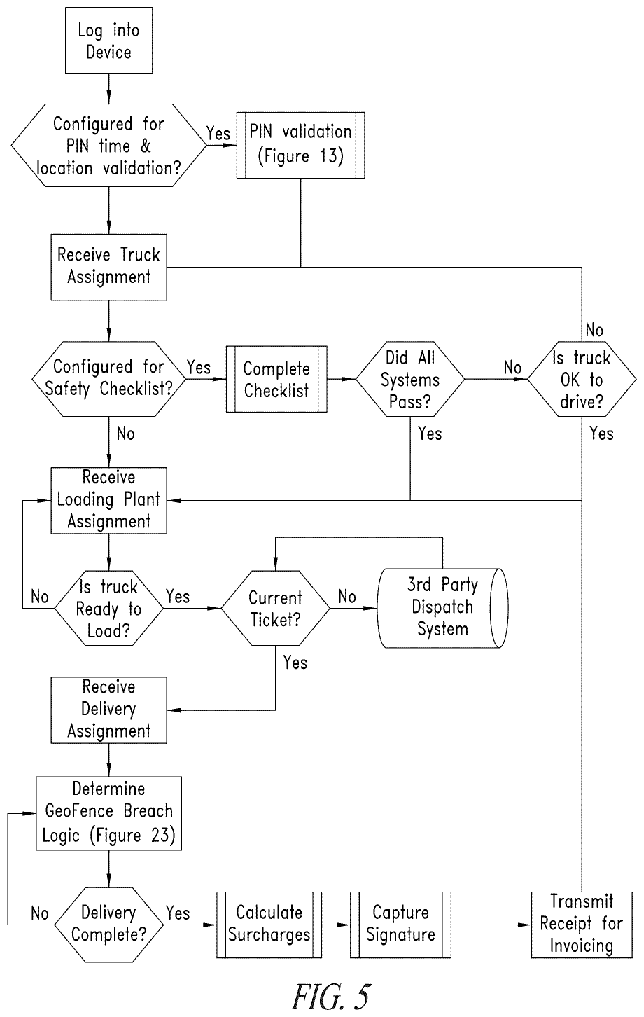

FIG. 5 is a flowchart illustrating the overall conceptual operation of the system. Not all of the depicted actions may be required and implementations will include additional components or features.

The vehicle's relationship to a geozone can be determined by the system. To determine whether a geographic location representing a vehicle is inside or outside a specific geozone, the number of intersects of a specific geofence can be counted by holding either the longitude or the latitude constant. If the number of intersects is odd, then the point is inside the geozone. If the number is even, then the location is outside the geozone. FIG. 6 is an illustration of the concept. In this example, the system counts the number of longitudinal intersects from an arbitrary frame of reference (in this case the longitude of the trucks default plant) along a constant latitude until it reaches the current position of the truck. In FIG. 6, the number of intersects is odd (1) so the location is determined to be inside the geozone.

Users can set relationships between events, geofence breaches and specific geozone types. Exemplary non-limiting geozone types are depicted in Table 2 below.

TABLE 2

| Geozone Type | Description |
|---|---|
| Delivery | Geozone tied to a specific delivery event. Entrance |
| | into the geozone can auto-trigger a status change. |
| Pricing | Geozones created to control pricing based upon |
| | distance, travel times, or market forces. |
| Informational | Geozones created to trigger alerts when certain |
| | conditions are met. |
| Pay Factoring | Geozones created to record a change in a driver's pay |
| | rate when deliveries pass through a geozone |
| Payroll/Punches | Geozones created to define the area a device must be |
| | within to accept and employee punch in/out. |

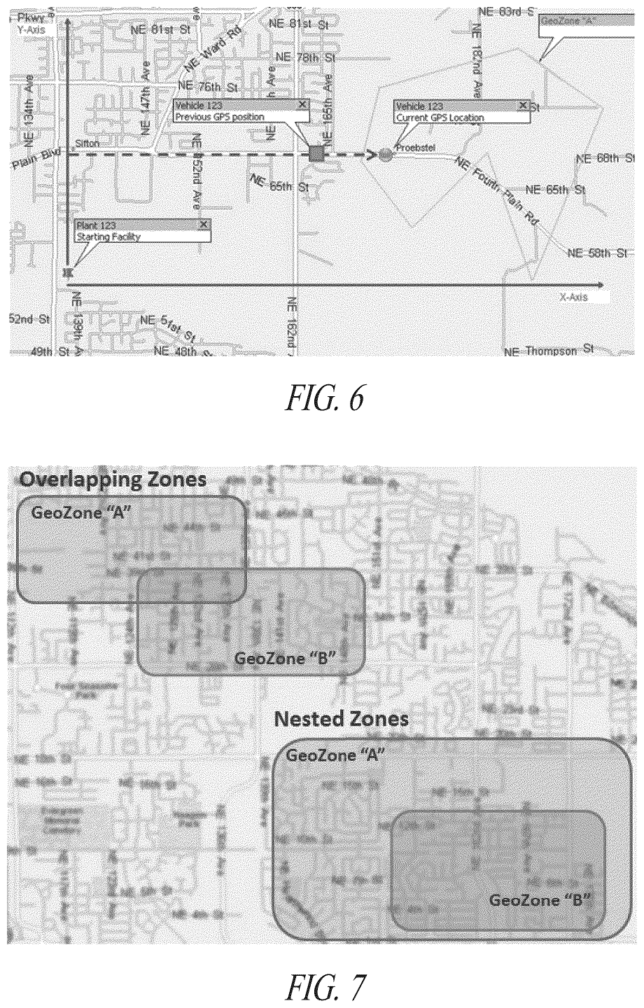

Geozones can be “stacked” over a common geographical area. The stacking can be complete (one geozone completely inside another) referred to as “nested” or can overlap where a partial area is common to both. FIG. 7 is an illustration of stacked geozones. When the same type geozones are stacked, the user can set relationship attributes between them defining exclusivity, precedence, and/or aggregation rules to interpret common data points. Table 3 below includes relationship attributes for the selection factors of common geozone types.

TABLE 3

| Attribute | Description |
|---|---|
| Exclusivity | Refers to whether the geozones are mutually exclusive or not. If |
| | TRUE, based on the precedence setting, only one GeoZone can |
| | be selected. This can be used to construct an overall zoning map |
| | where a zone may contain overrides within it. |
| Precedence | Used to determine which GeoZone should be selected when more |
| | than one covers the supplied GPS point and exclusivity is in effect. |
| | This can be controlled by a user-defined precedence or pre- |
| | determined criteria. |
| Aggregation | Used for relating GeoZones that do not overlap, but need to be |
| | aggregated to determine pricing. An example would be a |
| | customer with multiple active job sites during a day, and a |
| | collective rental charge needs to be calculated for the total duration |
| | within all the geozones. |

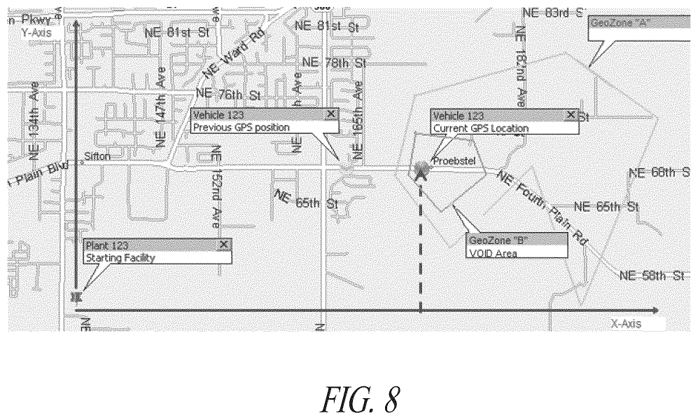

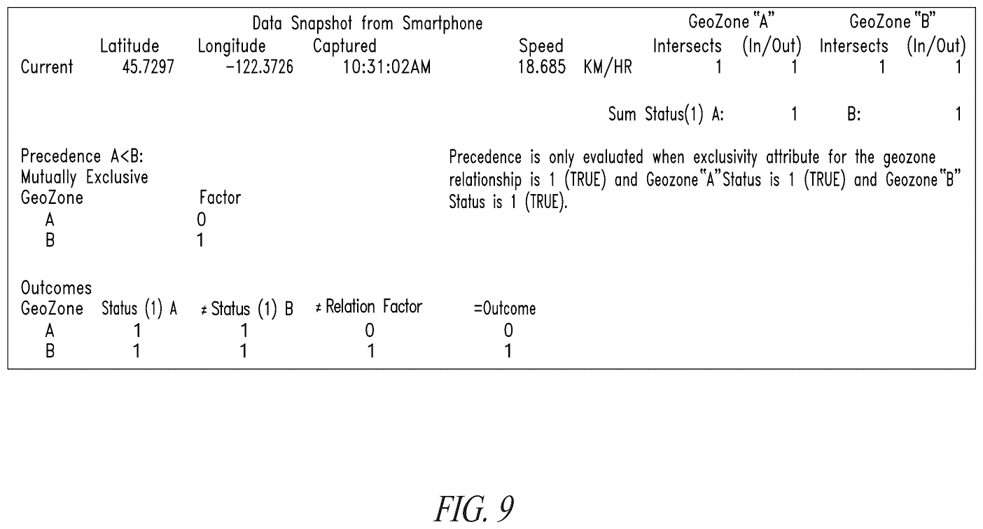

FIG. 8 is an illustration to demonstrate the logic for nested geozones. In FIG. 8, an additional geozone, Geozone “B” is added on top of Geozone “A” to form a nested geozone. For illustration purposes, in this case the relationship between the geozones is defined as mutually exclusive. A device is in either Geozone A or Geozone B, it cannot be in both geozones at the same time. The precedence is set to A<B (B takes precedence over A). A device at 45.7297, −122.3726 would be evaluated as depicted in FIG. 9, the device is located with Geozone “B”. If the precedence had been set to A>B, then the device would be reported as being located within Geozone “A”; if no precedence has been set (the geozones are not mutually exclusive), the device would be reported as being in both “A” and “B”.

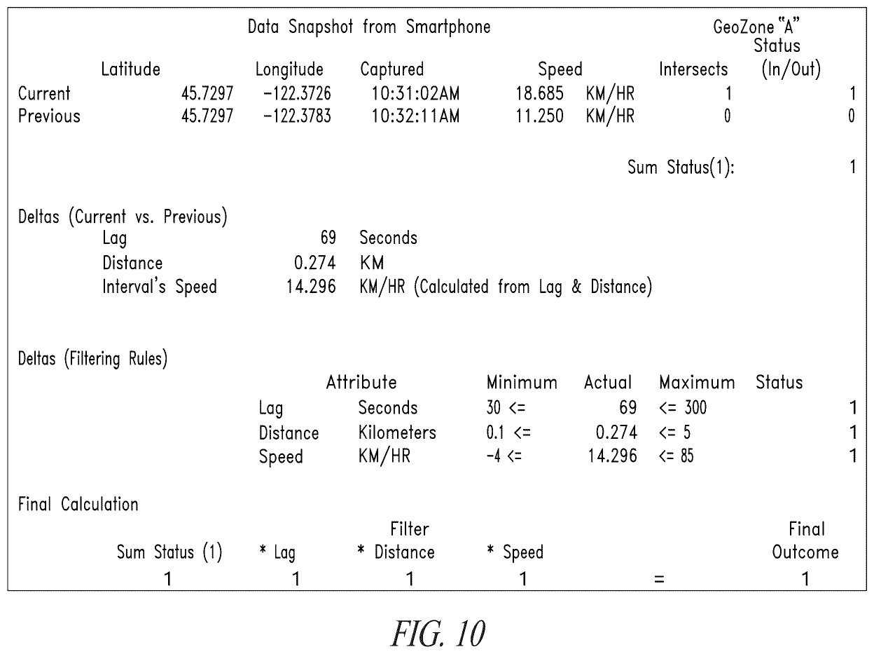

Reported geofence breaches can be filtered by comparing the time and distance differential between the reported time and geographic location when the breach is determined and the previously recorded geographic location for the device. Filtering values can be configured to block stale or errant GPS readings. The filtering value comparisons are assigned bit values of 1 if within the allowed range, 0 if outside the acceptable range. The filtering values are then multiplied against the total value. If the value is 1, then the reported GPS reading (and therefore geofence breach) is acceptable. FIG. 10 is an example of the geofence breach filtering evaluation.

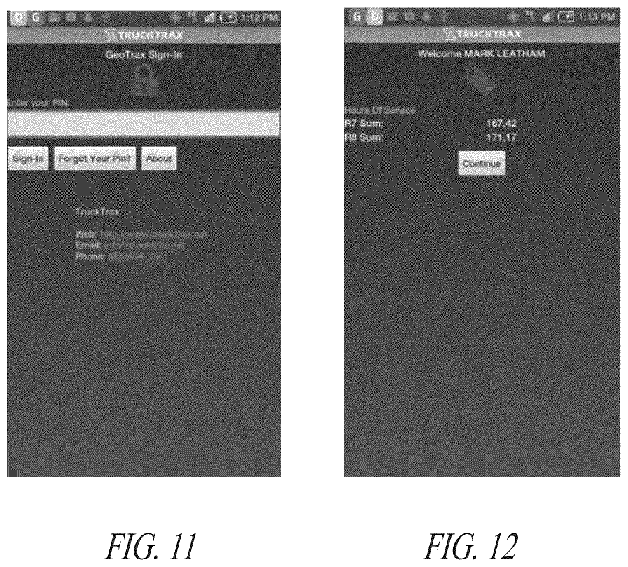

FIG. 11 is a screenshot showing a user interface that may display with the first interaction with the system. The user interface allows the user to enter identification information, such as login credentials, in order to access the system. The screen may include a login subsection that includes a login field, a Personal Identification Number (PIN) field, a sign-in (submit) button, and a Help button.

If the login ID and PIN match an existing record in the employee file and the application verifies a valid subscription, a welcome screen appears and the cumulative time worked and communications subsections display on the user interface. Other types of logging routines can also be used.

Upon logging in, the time, GPS coordinates or other information may be transmitted to a web application such that the device acts as an electronic time card. Upon receipt of the information (e.g., login name, PIN, time of day, and GPS coordinates of the device), the web application may compare the received data to stored information. If the time is within a predetermined range of the employees scheduled start time and the location is within a previously identified acceptable geozone, then the user is allowed to continue with the login process. If either condition is not met, a countdown may display that prohibits the user from continuing.

FIG. 12 is a screenshot of a user interface welcome screen that may contain a cumulative time worked subsection and a time worked subsection. The cumulative time worked subsection may include, without limitation, driver qualifications, the cumulative hours worked in the current pay period, cumulative hours worked year-to-date, current FMSCA hours of service compliance and any incentive based metrics, or the like. The communication subsection may include, without limitation, the scheduled start time, news items related to the system and other information needed by the employee, or the like.

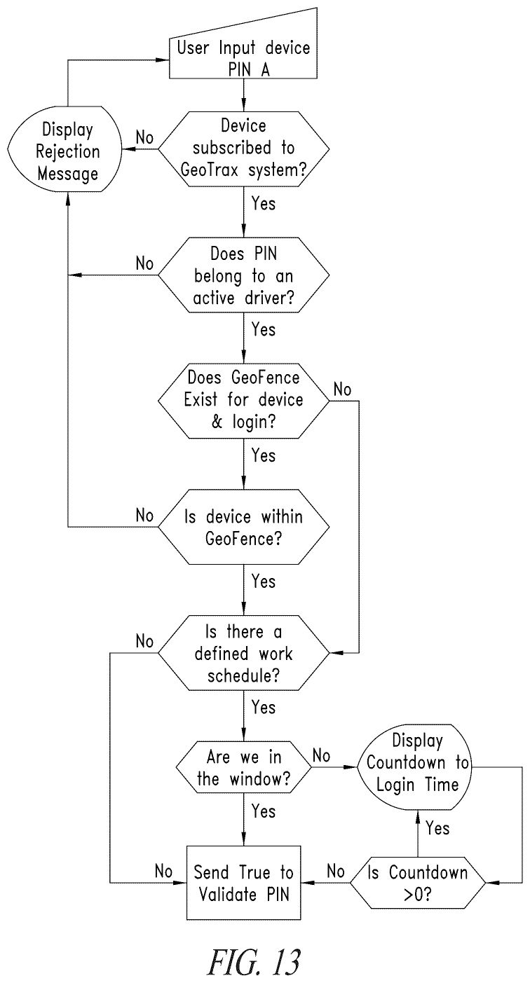

FIG. 13 is a flowchart illustrating a validation process using a Personal Identification Number (PIN). When the PIN is entered into the device, the application determines if the device has a current subscription and if the device is within a pre-determined geozone. If so, the system checks that there is a work schedule for the employee and that the attempted login is within a pre-approved time window. If so, the PIN is validated and the process continues. If not, the user is informed of the failure.

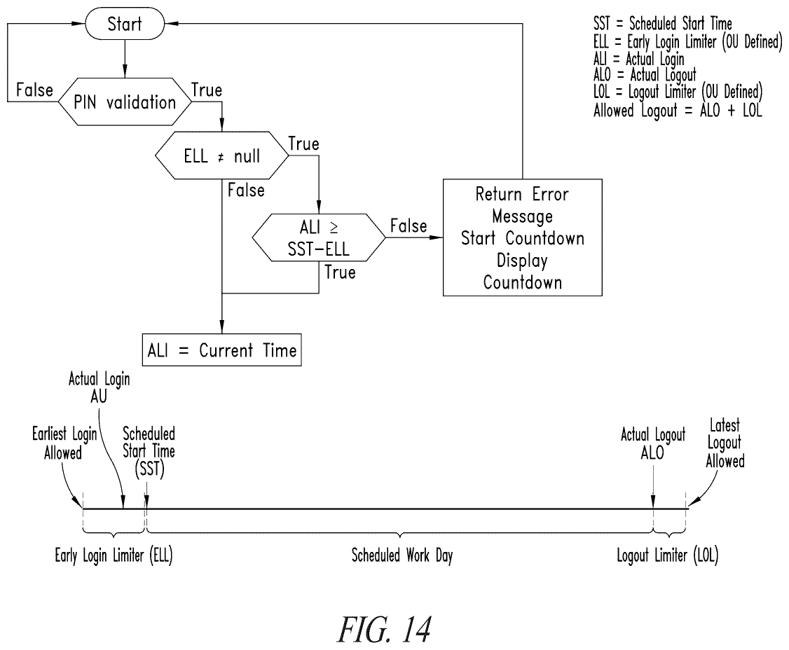

FIG. 14 shows the logic that determines whether an attempted user login meets one or more criteria. One criterion is whether the login is performed within a pre-approved time window so the application can function as an electronic time card. The application can determine whether the user is already logged into the system. If yes, then the device syncs up with the current logged in session. If no, the application determines the relationship between the login time and the users scheduled start time. If the login is at or after the scheduled time, then the login is accepted. If the login is before the user's scheduled start time, the application determines whether the time is within a configurable acceptable time window. If yes, the login is accepted; if no, the login is rejected and a countdown to the acceptable window is displayed.

The logic routine for identifying an early login can be used to evaluate other events. By way of example, the logic routine can be altered to notify a dispatcher that the user is approaching a pre-determined event (e.g., “lunch window”), or can be modified to a logout routine after the actual logout event or scheduled shift end. In the ready-mixed concrete industry application, the routine can allow employees to stay “on the clock” for pre-determined lengths of time after deliveries are completed in order to perform housekeeping duties. The application permits additional time to be allowed after the logout event has occurred.

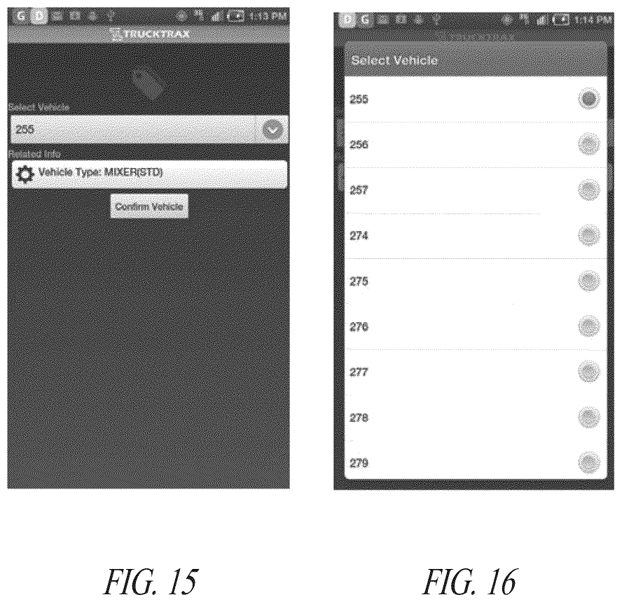

FIG. 15 is a screenshot of a user interface that may contain the Identification number of the vehicle that the user is scheduled to drive according to the predetermined schedule contained in the web application. The vehicle Identification number field is interactive, by pressing the down arrow on the field a drop-down list of acceptable alternative vehicles is displayed (FIG. 16). The acceptable vehicle list presented can be filtered based on cargo requirements and/or driver qualifications.

In an alternative embodiment, the device may communicate wirelessly via short wavelength radio transmissions (e.g., a BLUETOOTH® connection) with the trucks internal systems to automatically determine the vehicle ID number. Other types of transmissions and information can be transmitted.

The user may select an alternative vehicle by pressing the box containing the alternative identification number and highlighting the field. The alternative will automatically be returned and the drop down list closed. The vehicle type may also be displayed to assist the user in their choice of alternative. The user may confirm the choice by pressing the “Confirm Vehicle” button.

The user interface may display a configurable Vehicle Pre-Trip Safety Checklist. Other types of checklists can be utilized if needed or desired. After selection, the employee may confirm that the vehicle's operating systems are performing properly. After visually inspecting each component, the user may press the associated field on the user interface to designate each of the vehicle's systems as either “Pass” or “Fail”. Pressing the “Not Checked” field once indicates that the system passed inspection. Pressing the field a second time denotes that the system failed. After all of the vehicle's systems have been designated, the “Submit Checklist” button is highlighted. When pressed, the information is transmitted to the web application for reckoning. If one or more systems were designated as “Fail”, then management input may be required to clear the designation and allow the user to continue with the substandard vehicle. Once validated, the mobile device can be tethered to the vehicle and communication from other vehicles' wireless devices is filtered out. If desired, when an electronically tethered mobile device loses contact with the truck it's assigned to, communication from the device may be suspended or disavowed until contact is re-established. For example, if a driver is away from the truck, even if it is in a plant loading queue geozone, the ready to load status will not be sent until the driver returned to the truck. On a configurable basis, other communication blocks can be utilized if needed or desired.

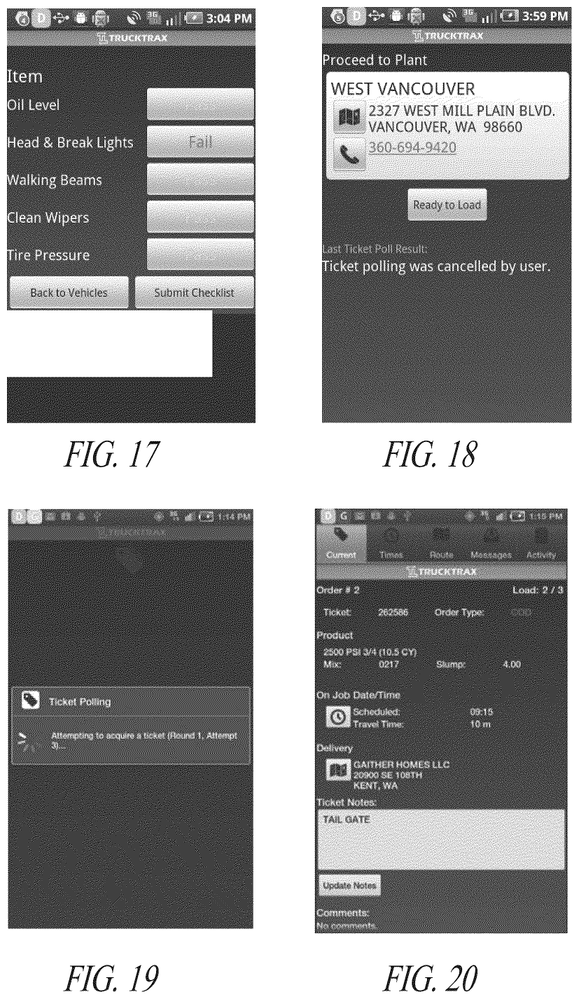

FIG. 17 is a screenshot of a user interface displaying a completed Vehicle Pre-Trip Safety Checklist with a failed system prior to submission.

FIG. 18 is a screenshot of a user interface that may display the location of the next payload for the user and vehicle as predetermined in the web application. By pressing the ready to proceed button labeled “Ready to Load” or the like, the user transmits to a dispatch office via the web application that they are ready to proceed and the web application polls the 3rd party dispatch software for the next scheduled delivery. An alternative method for determining a vehicle's readiness to receive a payload is its location within a batching plant's loading queue geozone.

FIG. 19 is a screenshot of a user interface displaying the ticket polling screen. To reduce drain on the device's battery, the mobile application will poll the for a delivery ticket three times for a configurable length of time (typically about 10 seconds), then sleep a configurable length of time (typically 60 seconds).It will continue this process a configurable number of times (typically 100 times) or until the device receives a valid, unfulfilled ticket or the application is terminated. After polling to the device's configured maximum polling attempts, the application will cease polling and return back to the ‘Ready-to-Load’ initiation screen (FIG. 18)

FIG. 20 is a screenshot of a user interface that displays the designated vehicle's next delivery information. Upon receiving the “Ready to Load” status from the device, the application may search for the next scheduled delivery for the vehicle. The Ticket Number, Credit type, all Product Number(s), Product Description(s), and other pertinent descriptions of the product(s) are displayed on the user interface. The Delivery Address, Customer Information and scheduled arrival time are also displayed. Along with the ticket information, the GPS coordinates and designated jobsite geozone is transmitted along with all the necessary information needed to complete all the billing calculations related to time and location and any relevant surcharges.

The user interface may display an interactive ticket note field. If notes have been sent with the delivery ticket, they can be displayed in the notes field. The user can edit or annotate the notes by pressing inside the field, causing the virtual keyboard to display. The user can enter additional notes by pressing the appropriate keys on the keyboard or by selecting the “microphone” key and speaking into the microphone of the device. The device (e.g., using native speech recognition software, third party speech recognition software, etc.) can translate the spoken notes and put them in the notes field. The user interface also displays any comments on the ticket in a non user-editable field.

If navigation (e.g., turn by turn navigation) is available on the device, pressing the appropriate button will open up the program, populate the destination field with the delivery location, and initialize the application. For certain mobile devices, pressing the appropriate button can speed dial the telephone number for the delivery location and allow the user to speak with a representative on the built-in cellular telephone. The device may be able to function in both an online and an offline mode at this point. The information may be cached in a local data store for offline operations and completion of the delivery ticket. The local and remote data stores may synchronize when online operations are available.

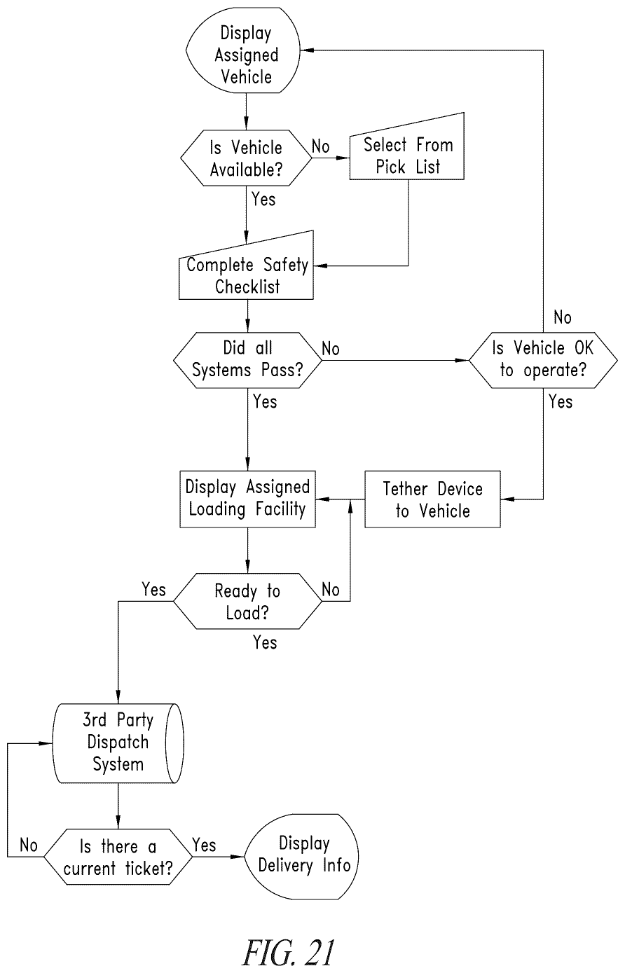

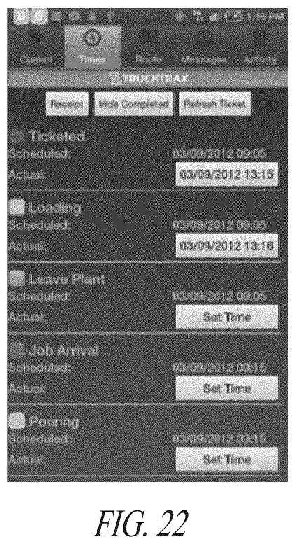

A flowchart for the above vehicle validation and delivery assignment display procedure of the system is shown in FIG. 21.

FIG. 22 is a screenshot of a user interface displaying the delivery event times for the ticket determined by the application. Actual event times, scheduled times, or other times are displayed when the user presses the “Times” button on the user interface. The load time may be transmitted to the device as a ticket update from the web application.

An alternative method could be established by using comparative GPS coordinates. When a built-in GPS receiver of the mobile device detects that it has left the loading geozone, the mobile device records the time of the event and sends a signal to the web application via either Wi-Fi or cellular communication. The mobile device continues to record information (e.g., positional data and accuracy, sensor data, etc.) and transmits it along with the time it occurs at configurable intervals. The determination of when a vehicle has breached a delivery geofence and is entering or exiting that specific geozone is based upon evaluation of the direction of movement between GPS coordinates, the delivery state, the current ticket status, and the order state.

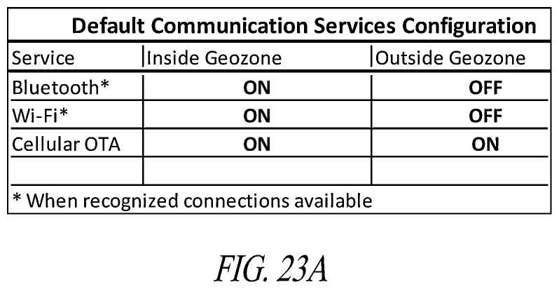

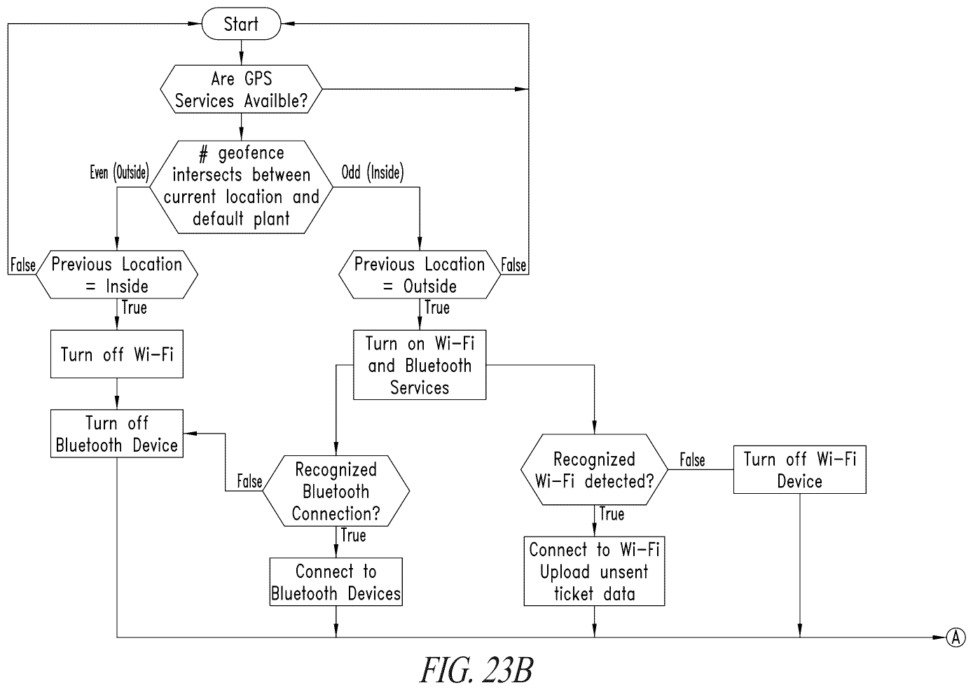

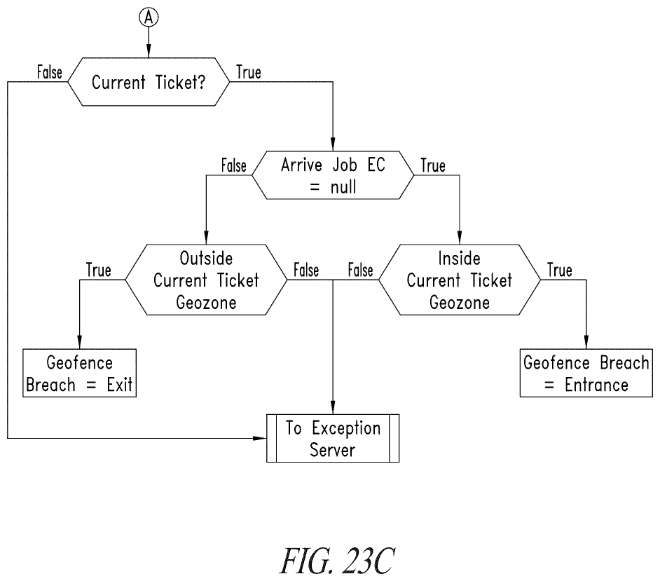

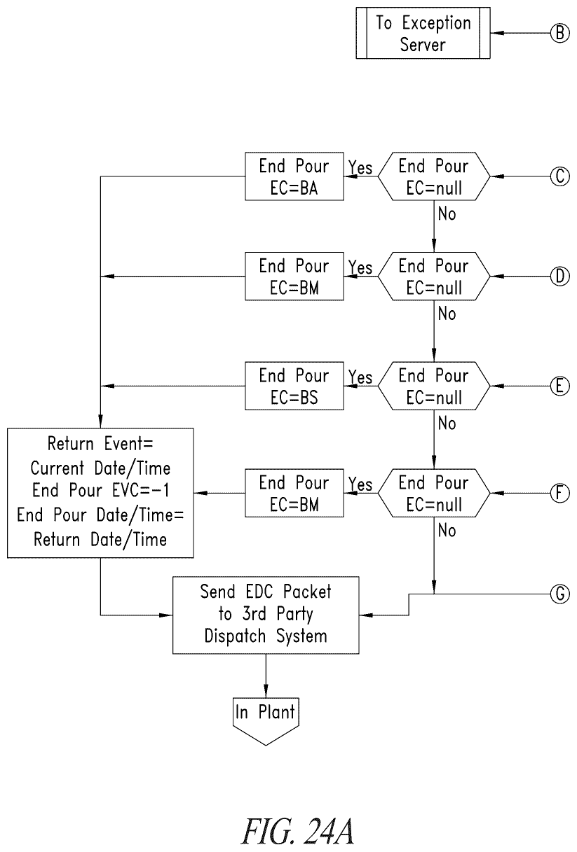

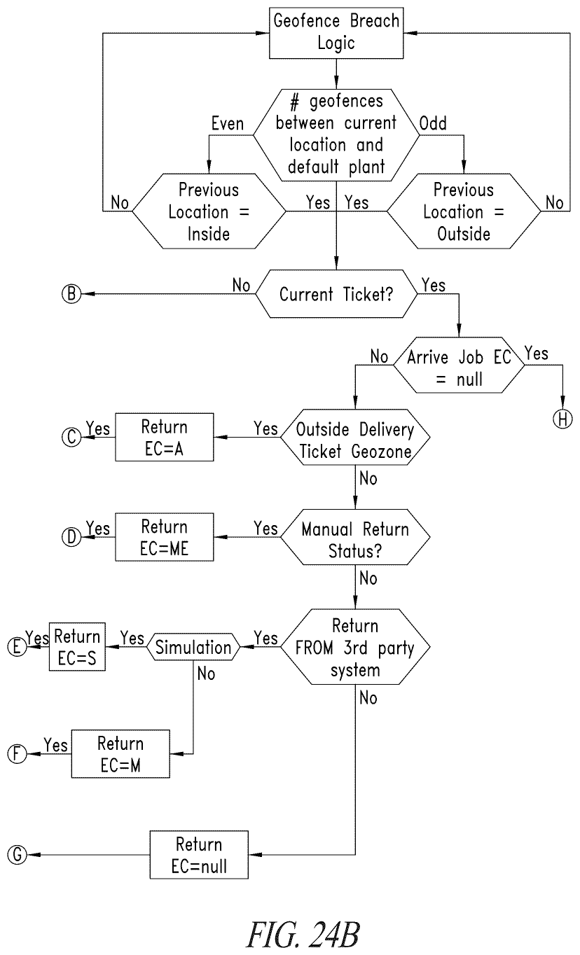

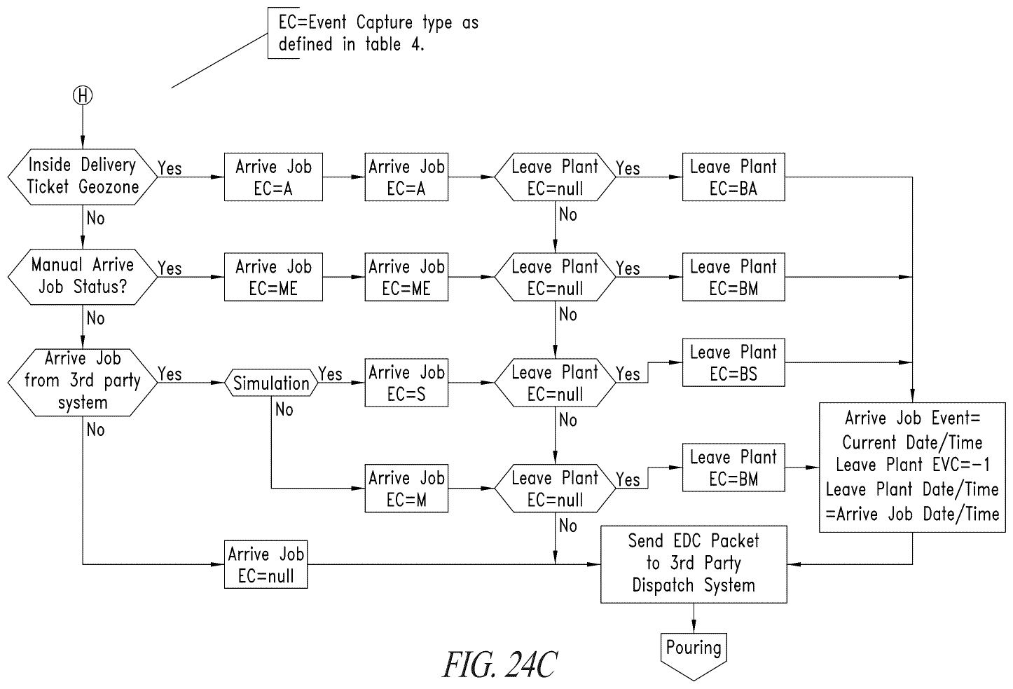

FIGS. 23B and 23C are a flowchart illustrating breach logic and its use in managing power, including battery life. When a breach is determined to be an entrance into a loading plant geozone or a delivery site, services can be turned ON. For example, both Wi-Fi and Bluetooth services can be turned ON. On a configurable basis, to conserve battery life if either service fails to recognize an authorized signal or if the breach is an exit, one or more service(s) may be turned OFF. FIG. 23A is a table depicting the default communication settings for maximizing battery life. Best-fit logic can be applied to a plurality of the events to determine the appropriate event times and apply the corresponding billing surcharge criteria as shown in FIGS. 24A, 24B, and 24C. On a configurable basis, some actual event times may be edited by the user by pressing the corresponding status button and using the mobile device's date and time tool. Delivery events are given a relative value based upon the type of capture and are configured to be transmitted to third party dispatching software based, at least on part, on the value. Table 4 describes the Event Capture Types and their relative values.

TABLE 4

| Event | | |
|---|---|---|
| Capture | | |
| ID | Value | Description |
| A | 100 | Automatic event time determination based upon sensor |
| | | readings and/or GPS coordinates |
| AB | −1 | Backfilled event time caused by tethered downstream |
| | | event receiving an automatic event time |
| G | 75 | Event time entered manually from mobile device |
| GB | −1 | Backfilled event time caused by a tethered downstream |
| | | event receiving an automatic event time |
| M | 70 | Manually entered event time from related 3^{rd} party |
| | | dispatch app |
| MB | −1 | Backfilled event time caused by a tethered downstream |
| | | event receiving a manually entered event time |
| S | 10 | Simulation driven event time |
| SB | −1 | Backfilled event time caused by a tethered downstream |
| | | event receiving a simulated event time |

Upon completion of the delivery, a receipt is displayed when the user presses the “View Receipt” button.

FIG. 25 is a screenshot of a user interface displaying the delivery manifest. The user interface displays the delivery information (e.g., customer information, load information, billing information, etc.), the product(s) delivered, and any surcharges calculated by the application. The mobile device can perform any number of calculations. Event and elapsed times are displayed for the customer's convenience.

The user interface may display a delivery recipient name field. The user can enter the recipient's name by pressing inside the field, causing the virtual keyboard to display. The user can enter spell out the name by pressing the appropriate keys on the keyboard or by selecting the “microphone” key and speaking into the microphone of the mobile device.

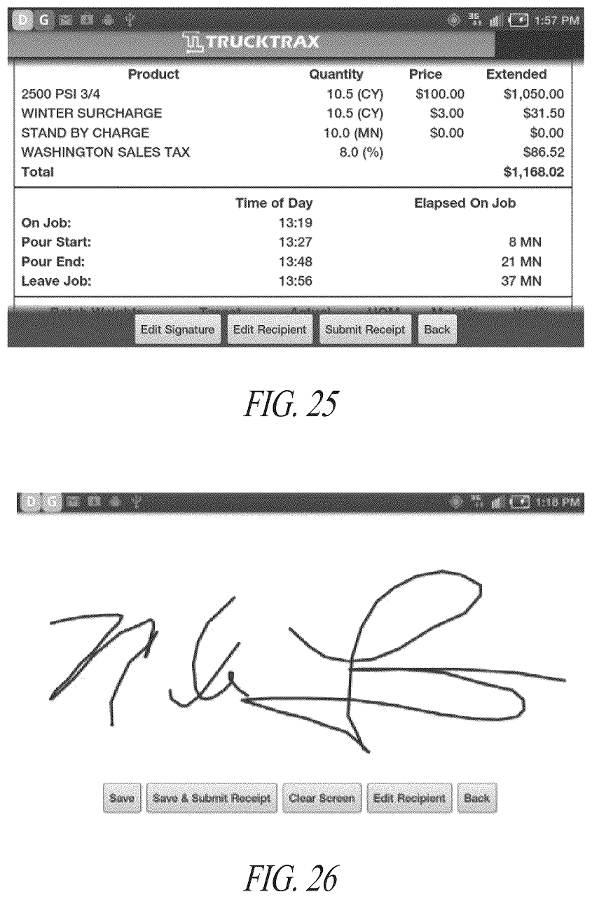

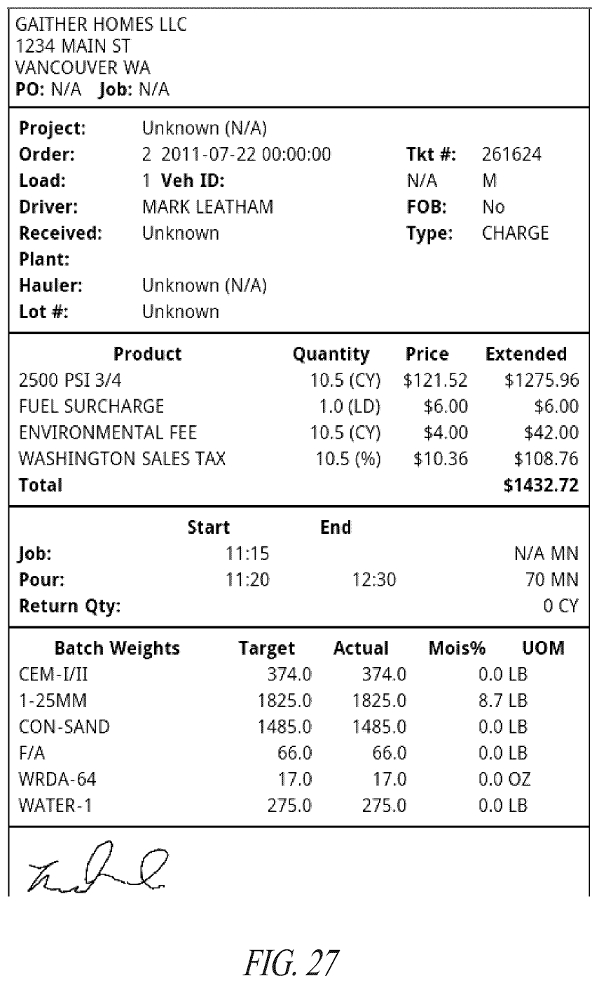

FIG. 26 is a screenshot of a user interface that displays the captured signature attached to the delivery receipt. The application uses a signature smoothing algorithm that allows the device to capture a legible signature produced with a finger. Upon completion of the delivery, the mobile device transmits via Wi-Fi or cellular network the delivery receipt to the web application for further distribution, if needed or desired. FIG. 27 is a screenshot of the electronic image of the delivery receipt. In another embodiment, the delivery receipt can be transmitted via BLUETOOTH® to a portable printer.

For deliveries requiring more than one truckload, the application may communicate to the point of sale software system to display on the device a map with the location and status of all subsequent loads that have been ticketed for the current customer. Coordination of the delivery sequence is improved resulting in a higher quality finished product. Customers who are subscribers can log into the web application to view the status of currently ticketed trucks, billing status of deliveries already completed, as well as invoice stage and account condition on their smartphone without having to leave the jobsite.

Screens may be provided in the user interface for receiving and displaying text communications from the web application. The user can respond by selecting a reply from a pre-configured pick list or a freeform response can be crafted by pressing inside the response field and selecting the appropriate keys on the keyboard or by selecting the “microphone” key and speaking into the microphone of the smartphone. The device's native speech recognition software will translate the spoken response and put it in the reply field.

The system may provide the user with an interface for the interactive display of employee training materials utilizing a Content Delivery Network (CDN) such as CacheFly, LimeLite, or Amazon to stream computer based training (CBT) to the mobile device. The training may include one or more CBT courses related to safety, environmental compliance, work procedures, etc. If the coursework is interrupted prior to completion, the device may “bookmark” the training materials and allow the user to complete the course at a later time from the spot where the interruption occurred. The CBT may include one or more questions at the conclusion of the course to test the user's retention of the training materials. The user may use the interface to select answers to the questions that best relate to the training materials. The system may automatically cache sensor data. The sensor data can include, without limitation, accelerometer data, gyroscopic data, geographic data (e.g., latitude, longitude, etc.). The sensor data can be used for recreation in the event of a sudden violent event. The precise land speed, the applied gravitational forces, and the direction of travel may be displayed.

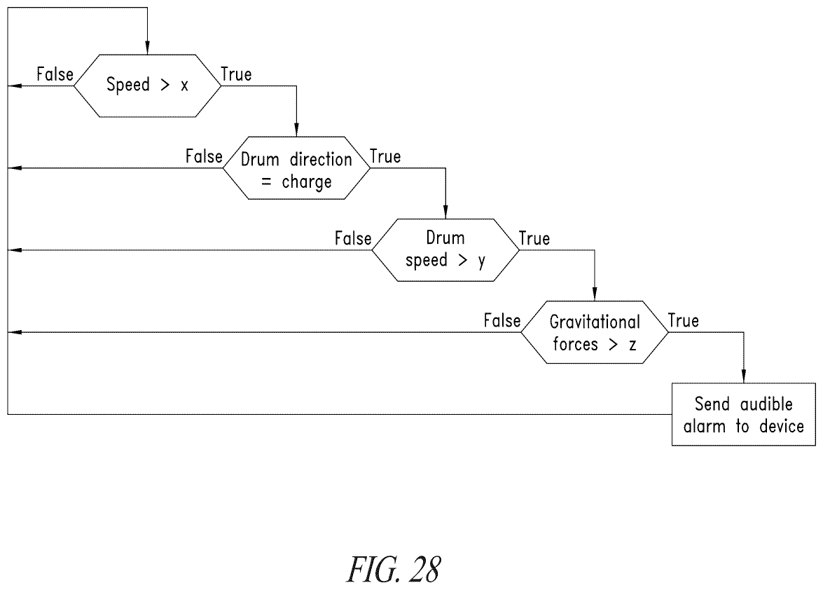

Ready-mixed concrete delivery trucks often have a revolving drum. The center of gravity of the revolving drum is located above the frame of the truck. The drum can be filled with concrete and can rotate in transit. When the truck is moving the drum typically spins in a clockwise direction causing the heavy payload to constantly shift from the center of the drum to the left hand (port) side of the truck. This movement when combined with the forces caused by sudden, sharp left hand turns causes ready-mixed concrete truck to suffer rollover accidents much more frequently than other types of delivery trucks. Sensor data (e.g., accelerometer data) accumulated by the application may be used for training, recreation of rollover accidents as well as near misses. FIG. 28 is a flowchart illustrating an example of the logic used to evaluate data and alert the driver of a possible rollover situation. The mobile device can be held in a docking station or other type of holder to ensure that proper data is collected. The mobile device can periodically transmit data. In other embodiments, the data is stored in memory of the mobile device.

The acts, methods, algorithms, and routines described in connection with the embodiments disclosed herein may be embodied directly in hardware, in a software module executed by a computing device, or combinations thereof. Software or a software module may be stored in memory. Memory can include, without limitation, volatile memory, non-volatile memory, read-only memory (ROM), random access memory (RAM), and the like. Memory can store information including, without limitation, databases, libraries, tables, algorithms, records, audit trails, reports, settings, user profiles, or the like.

A non-limiting exemplary storage medium of a mobile device can be coupled to an internal processor. The processor can read information from, and write information to, the storage medium. In other embodiments, the storage medium is integral to the processor. The processor and the storage medium may reside in an ASIC. The ASIC may reside in a user terminal. In yet other embodiments, the processor and the storage medium may reside as discrete components in a user terminal. The mobile devices can have different types of processing units, storage mediums, ASICs, or the like. Sensors, microphones, speakers, and other modular internal components of the mobile device can also include ASICs.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1-20. (canceled)

21. A computing system, comprising:
a memory that stores computer instructions; and
a processor that performs actions when executing the computer instructions, the actions including:
identifying ready-mix concrete for delivery from a first location to a second location, wherein the ready-mix concrete includes a plurality of portions that are aggregated when delivered to the second location;
defining a first geozone for the first location using a first geofence;
defining a second geozone for the second location using a second geofence;
tracking a location of a mobile computing device;
determining a first number of times the mobile computing device has intersected the first geofence of the first geozone by holding either the longitude or the latitude constant during the tracking of the location of the mobile computing device to the first location;
in response to determining that the first number of times the mobile computing device has intersected the first geofence is odd, determining that the mobile computing device has entered the first geozone;
in response to determining that the mobile computing device has entered the first geozone:
receiving a request to proceed with pick up of a portion of the plurality of portions for the ready-mix concrete;
causing a ticket corresponding to the portion to be displayed to the user on the mobile computing device;
instructing the user to pick up the portion of the plurality of portions of the ready-mix concrete in accordance with the ticket;
determining a second number of times the mobile computing device has intersected the first geofence of the first geozone by holding either the longitude or the latitude constant during the tracking of the location of the mobile computing device through the first geozone;
in response to determining that the second number of times the mobile computing device has intersected the first geofence is even, determining that the mobile computing device has exited the first geozone;
in response to determining the mobile computing device has exited the first geozone, updating the ticket with information regarding the portion picked up by the user;
determining a number of times the mobile computing device has intersected the second geofence of the second geozone by holding either the longitude or the latitude constant during the tracking of the location of the mobile computing device from the first location to the second location;
in response to determining that the number of times the mobile computing device has crossed the second geofence is odd, determining that the mobile computing device has entered the second geozone; and
in response to determining that the mobile computing device has entered the second geozone:
receiving an indication that the portion has been delivered to the second location; and
in response to receiving the indication that the portion has been delivered to the second location, automatically dispatching a subsequent portion of the plurality of portions of the ready-mix concrete to be picked up at the first location for delivery to the second location.

22. The computing system of claim 21, wherein the processor causes the ticket to be displayed to the user on the mobile computing device by performing further actions when executing the computer instructions, the further actions including:
causing previous and subsequent delivery information associated with the plurality of portions of the ready-mix concrete to be displayed with the ticket to the user on the mobile computing device.

23. The computing system of claim 21, wherein the processor causes the ticket to be displayed to the user on the mobile computing device by performing further actions when executing the computer instructions, the further actions including:
causing the mobile computing device to display an address of the second location to the user.

24. The computing system of claim 21, wherein the processor automatically dispatches the subsequent portion of the plurality of portions of the ready-mix concrete to be picked up at the first location for delivery to the second location by performing further actions when executing the computer instructions, the further actions including:
generating a second ticket corresponding to the subsequent portion of the plurality of portions of the ready-mix concrete;
causing the second ticket to be displayed to a second user of a second mobile computing device; and
instructing the second user to pick up the subsequent portion of the plurality of portions of the ready-mix concrete in accordance with the second ticket.

25. The computing system of claim 21, wherein the processor receives the request to proceed with pick up of the portion of the plurality of portions for the ready-mix concrete by performing further actions when executing the computer instructions, the further actions including:
receiving user input from the mobile computing device indicating that the user is ready to pick up of the portion of the plurality of portions for the ready-mix concrete.

26. The computing system of claim 21, wherein the processor receives the request to proceed with pick up of the portion of the plurality of portions for the ready-mix concrete by performing further actions when executing the computer instructions, the further actions including:
receiving an indication that the mobile computing device is tethered to a vehicle and ready to pick up of the portion of the plurality of portions for the ready-mix concrete.

27. The computing system of claim 21, wherein the processor performs further actions when executing the computer instructions, the further actions including:
displaying a map that shows locations of each portion of the plurality of portions in process of being delivered to from the first location to the second location.

28. The computing system of claim 21, wherein the processor performs further actions when executing the computer instructions, the further actions including:
determining that the mobile computing device has entered a third geozone; and
in response to determining that the mobile computing device has entered the third geozone, triggering an alert that the portion of the plurality of plurality of portions for the bulk perishable product has entered an informational geozone.

29. A method, comprising:
identifying a bulk perishable product for delivery from a first location to a second location, wherein the bulk perishable product includes a plurality of portions that are aggregated when delivered to the second location;
defining a first geozone for the first location using a first geofence;
defining a second geozone for the second location using a second geofence;
tracking a location of a mobile computing device;
determining that the mobile computing device has entered the first geozone;
in response to determining that the mobile computing device has entered the first geozone:
receiving a request to proceed with pick up of a portion of the plurality of portions for the bulk perishable product;
causing a ticket corresponding to the portion to be displayed to the user on the mobile computing device;
instructing the user to pick up the portion of the plurality of portions of the bulk perishable product in accordance with the ticket;
determining that the mobile computing device has exited the first geozone;
in response to determining the mobile computing device has exited the first geozone, updating the ticket with information regarding the portion picked up by the user;
determining that the mobile computing device has entered the second geozone; and
in response to determining that the mobile computing device has entered the second geozone:
receiving an indication that the portion has been delivered to the second location; and
in response to receiving the indication that the portion has been delivered to the second location, automatically dispatching a subsequent portion of the plurality of portions of the bulk perishable product to be picked up at the first location for delivery to the second location.

30. The method of claim 29, wherein causing the ticket to be displayed to the user on the mobile computing device comprises:
causing previous and subsequent delivery information associated with the plurality of portions of the bulk perishable product to be displayed with the ticket to the user on the mobile computing device.

31. The method of claim 29, wherein causing the ticket to be displayed to the user on the mobile computing device comprises:
causing the mobile computing device to display an address of the second location to the user.

32. The method of claim 29, wherein automatically dispatching the subsequent portion of the plurality of portions of the bulk perishable product to be picked up at the first location for delivery to the second location comprises:
generating a second ticket corresponding to the subsequent portion of the plurality of portions of the bulk perishable product;
causing the second ticket to be displayed to a second user of a second mobile computing device; and
instructing the second user to pick up the subsequent portion of the plurality of portions of the bulk perishable product in accordance with the second ticket.

33. The method of claim 29, wherein receiving the request to proceed with pick up of the portion of the plurality of portions for the bulk perishable product comprises:
receiving user input from the mobile computing device indicating that the user is ready to pick up of the portion of the plurality of portions for the bulk perishable product.

34. The method of claim 29, wherein receiving the request to proceed with pick up of the portion of the plurality of portions for the bulk perishable product comprises:
receiving an indication that the mobile computing device is tethered to a vehicle and ready to pick up of the portion of the plurality of portions for the bulk perishable product.

35. The method of claim 29, further comprising:
displaying a map that shows locations of each portion of the plurality of portions in process of being delivered to from the first location to the second location.

36. The method of claim 29, further comprising:
determining that the mobile computing device has entered a third geozone; and
in response to determining that the mobile computing device has entered the third geozone, triggering an alert that the portion of the plurality of plurality of portions for the ready-mix concrete has entered an informational geozone.

37. The method of claim 29, wherein determining that the mobile computing device has entered the first geozone comprises:
determining a number of times the mobile computing device has intersected the first geofence of the first geozone by holding either the longitude or the latitude constant during the tracking of the location of the mobile computing device to the first location; and
in response to determining that the number of times the mobile computing device has intersected the first geofence is odd, determining that the mobile computing device has entered the first geozone.

38. A non-transitory processor-readable medium storing computer instructions that, when executed by a processor, cause the processor to perform actions, the actions comprising:
identifying an aggregate product for delivery from a first location to a second location, wherein the aggregate product includes a plurality of portions that are aggregated when delivered to the second location;
defining a first geozone for the first location using a first geofence;
defining a second geozone for the second location using a second geofence;
tracking a location of a mobile computing device;
determining that the mobile computing device has entered the first geozone;
in response to determining that the mobile computing device has entered the first geozone:
receiving a request to proceed with pick up of a portion of the plurality of portions for the aggregate product;
causing a ticket corresponding to the portion to be displayed to the user on the mobile computing device;
instructing the user to pick up the portion of the plurality of portions of the aggregate product in accordance with the ticket;
determining that the mobile computing device has exited the first geozone;
in response to determining the mobile computing device has exited the first geozone, updating the ticket with information regarding the portion picked up by the user;
determining that the mobile computing device has entered the second geozone; and
in response to determining that the mobile computing device has entered the second geozone:
receiving an indication that the portion has been delivered to the second location; and
in response to receiving the indication that the portion has been delivered to the second location, automatically dispatching a subsequent portion of the plurality of portions of the aggregate product to be picked up at the first location for delivery to the second location.

39. The non-transitory processor-readable medium of claim 38, wherein automatically dispatching the subsequent portion of the plurality of portions of the bulk perishable product to be picked up at the first location for delivery to the second location comprises:
generating a second ticket corresponding to the subsequent portion of the plurality of portions of the bulk perishable product;
causing the second ticket to be displayed to a second user of a second mobile computing device; and
instructing the second user to pick up the subsequent portion of the plurality of portions of the bulk perishable product in accordance with the second ticket.

40. The non-transitory processor-readable medium of claim 38, wherein determining that the mobile computing device has entered the first geozone comprises:
determining a number of times the mobile computing device has intersected the first geofence of the first geozone by holding either the longitude or the latitude constant during the tracking of the location of the mobile computing device to the first location; and
in response to determining that the number of times the mobile computing device has intersected the first geofence is odd, determining that the mobile computing device has entered the first geozone.
